(19) United States
(12) Patent Application Publication
(10) Pub. No.: US 2009/0177497 A1
(43) Pub. Date: Jul. 9, 2009

(54) Ophthalmic Surgical Systems with Automated Billing Mechanism

(76) Inventors: Ferenc Raksi, Mission Viejo, CA (US); Ronald M. Kurtz, Irvine, CA (US); Eric Weinberg, Rancho Santa Fe, CA (US)

Correspondence Address: FISH & RICHARDSON, PC, P.O. BOX 1022, MINNEAPOLIS, MN, 55440-1022, US

(21) Appl. No.: 12/351,752

(22) Filed: Jan. 9, 2009

Related U.S. Application Data
(60) Provisional application No. 61/020,074, filed on Jan. 9, 2008.

(51) Int. Cl. G06Q 50/00; G06Q 40/00; G06Q 90/00

(52) U.S. Cl. 705/3; 705/2; 705/4; 705/34

(57) ABSTRACT

A system and method for billing for one or more surgical procedures includes a treatment planning module to accept input selecting multiple surgical procedures, a patient data management module to provide patient data, and a billing module to charge different payers for the selected surgical procedures in relation to the patient data, wherein the control system is operable to communicate with a surgical apparatus, configured to perform the selected multiple procedures. The system can include a user interface to provide a treatment planning menu to select surgical procedures, a payer sources menu, to input identification of the different payers, and a payer factor menu, to input factors impacting coverage by the different payers. A method of billing for one or more surgical procedures includes accepting input selecting multiple surgical procedures, accepting input regarding patient data, and charging different payers for the selected surgical procedures in relation to the patient data.

### CROSS REFERENCE TO RELATED APPLICATION

This application claims benefit from and priority of provisional application “Ophthalmic surgical systems with automated billing mechanism”, Ser. No.: 61/020,074, filed on Jan. 9, 2008, which provisional application is hereby incorporated in its entirety by reference.

### BACKGROUND

This application relates to ophthalmic surgical systems and operations of such systems.

Certain ophthalmic surgical systems include, or are connected to, a computer which provides various levels of control over the operation of the ophthalmic surgical systems. Many of these computer controlled ophthalmic surgical systems make use of lasers. The involvement of computers allows improved billing procedures for the surgical procedures.

### SUMMARY

A system and method for billing for surgical procedures is provided. In some implementations a control system to bill for surgical procedures includes a treatment planning module to accept input selecting multiple surgical procedures, a patient data management module to provide patient data, and a billing module to charge different payers for the selected surgical procedures in relation to the patient data, wherein the control system is operable to communicate with a surgical apparatus, configured to perform the selected multiple procedures.

In some implementations the patient data includes data regarding coverage of the selected procedures by an insurer of the patient.

In some implementations the different payers include two or more insurance companies, or an insurance company and the patient.

In some implementations different procedures are charged to different payers.

In some implementations portions of different procedures are charged to different payers.

In some implementations the system includes a user interface to provide menus for a user of the control system.

In some implementations the menus include a treatment planning menu to select surgical procedures, a payer sources menu, to input identification of the different payers, and a payer factor menu, to input factors impacting coverage by the different payers.

In some implementations the system is configured to perform an algorithm to charge the different payers according to the patient data.

In some implementations the algorithm includes: evaluating whether a selected procedure is covered by a payer at least partially, charging at least a part of the cost of the selected procedure to the payer if the selected procedure is covered by the payer at least partially, and charging another party if the selected procedure is not covered by the payer.

In some implementations one of the selected surgical procedures is a cosmetic or convenience procedure.

In some implementations the selected surgical procedures involve surgery on an eye.

In some implementations one of the selected procedures is a portion of a cataract surgery.

In some implementations another selected procedure is a corneal procedure.

In some implementations a method of billing for surgical procedures includes: accepting input selecting multiple surgical procedures, accepting input regarding patient data, and charging different payers for the selected surgical procedures in relation to the patient data.

In some implementations the patient data includes data regarding coverage of the selected procedures by an insurer of the patient.

In some implementations the different payers include two or more insurance companies, or an insurance company and the patient.

In some implementations different procedures are charged to different payers.

In some implementations portions of different procedures are charged to different payers.

In some implementations the method further includes providing menus for a user of the system.

In some implementations the menus include a treatment planning menu to select surgical procedures, a payer sources menu, to input identification of the different payers, and a payer factor menu, to input factors impacting coverage by the different payers.

In some implementations the charging step includes performing an algorithm to charge the different payers according to the patient data.

In some implementations the performing the algorithm includes evaluating whether a selected procedure is covered by a payer at least partially, charging at least a part of the cost of the selected procedure to the payer if the selected procedure is covered by the payer at least partially, and charging another party if the selected procedure is not covered by the payer.

In some implementations one of the selected surgical procedures is a cosmetic or convenience procedure.

In some implementations the selected surgical procedures involve surgery on an eye.

In some implementations one of the selected procedures is a portion of a cataract surgery.

In some implementations another selected procedure is a corneal procedure.

In some implementations a control system to bill for a surgical procedure includes: a treatment planning module to accept input selecting a surgical procedure, a patient data management module to provide patient data, a billing module to charge different payers for portions of the cost of the selected surgical procedure in relation to the patient data, and a surgical interface to communicate with a surgical apparatus, configured to perform the selected surgical procedure.

In some implementations a computer-implemented method of billing for a surgical procedure includes: accepting input selecting a surgical procedure, accepting input regarding patient data, and charging different payers for portions of the cost of the selected surgical procedure in relation to the patient data.

### BRIEF DESCRIPTION OF DRAWINGS

FIG. 1 illustrates a surgical treatment platform.

FIG. 2 illustrates a billing procedure.

FIG. 3 illustrates an embodiment of an ophthalmic laser surgical system.

### DETAILED DESCRIPTION

Computers in ophthalmic surgical systems such as laser ophthalmic surgical systems can be used to control and automate certain operations of the laser, the optics and other components associated with laser surgery. In addition, a computer in such a surgical system can be programmed to provide automation of other processes in connection with the surgical procedures such as billing. Examples of laser ophthalmic surgical systems with computer-automated billing mechanisms are described in this document.

Such an integration of surgical operations and billing can provide efficient and streamlined ophthalmic surgical services to patients. Laser ophthalmic surgical systems with computer-automated billing mechanisms can be designed to perform what usually are or have been considered separate procedures in one sitting or session by automating a series of procedures which require individual procedure accounting to facilitate correct billing to specific payers. The integration of the billing and other automation mechanisms need not be limited to eye surgery, even though the examples discussed below describe some of the particular needs for such procedure accounting in this rapidly developing field. The described billing methods can be integrated with any other known surgical technique and procedure, by implementing appropriate modifications.

A number of different types of eye surgery have been developed in the past. Traditionally, a single surgical goal or at least an aligned set of goals was inherent in a particular surgery. For example, a primary goal of surgical treatments of the cornea was to change a corneal shape to correct a refractive error to reduce the patient's dependence on optical aides such as glasses or contact lenses. Examples of such corneal refractive surgeries include LASIK, PRK, astigmatic keratotomy and other procedures.

Another example of eye surgery is cataract surgery, in which an optically damaged lens is removed and replaced with a transparent artificial lens. Commonly performed since the 1970's, the goals of modern cataract surgery have evolved from simply providing a clear path for light transmission to the retina, to improving the refractive optics of the eye. This evolution of goals originally meant reducing the need for post-operative spectacles for distance vision. More recent developments include the introduction of specialized artificial lenses that also provide for unaided near vision.

While cataract and corneal surgeries have traditionally been performed as separate procedures, combined procedures are now becoming more common as surgeons take advantage of the benefits of surgical corrections performed on different optical components of the eye. A host of combination procedures have been advanced recently, some also involving additional implants placed in the cornea. Thus, surgeons addressing the visual needs of their patients may apply a combination of procedures to deliver improvements in multiple functional areas of vision, including clarity, brightness, refractive correction, binocularity etc.

While the patient may be advantaged by such combinations of procedures, the delivery of them may be complicated by the complex payment responsibilities that exist in many jurisdictions. For example, in some countries, certain procedures are included a set of covered services provided/paid for by the government or some other third party, while others are the responsibility of the patient. Typically, such third party “covered” services would be directed to the restoration of function due to disease or injury, while patients would be responsible for so called elective, cosmetic or “convenience” procedures. The rules regarding such distinctions can be complex, regional and can undergo rapid changes.

When procedures are performed in separate settings, either due to distinct timing and/or location, segregation of payment for such services can be relatively simple. However, as surgery evolves to improve results and convenience for patients, combination procedures require special consideration. For example, in combined corneal refractive and cataract surgery, the surgeon may perform lens replacement surgery, as well as a procedure such as astigmatic keratotomy (AK) to correct the patient's astigmatic refractive error so that glasses are not required post-operatively. In such a case, the surgeon may bill the patient directly for the AK procedure, while the insurer may pay for the cataract removal and replacement.

The criteria by which payment segmentations are made can vary by geography, insurer, medical condition, etc. For most combination procedures, distinct procedures can be identified and billed out separately. For example, in the above case, the AK procedure can be performed with instruments different from those of the cataract surgery, although usually within minutes of it. Separate costs, including surgeon time, supplies etc. can thus be accounted for relatively easily.

More recently, however, the distinction between procedures has been blurred with advances in surgical devices. For example, intraocular lenses can now provide both enhanced light transmission, as well as multifocality, correcting both what has traditionally been considered a medical condition (cataract), as well as providing elective refractive error correction (to reduce dependence on glasses). Some accounting methods have been developed that segregate the charges for each of these to their respective payer, with a portion paid for by the insurer for the medically necessary component and the remainder, related to the elective portion, paid for by the patient, for example.

While such conventions are workable for an implantable device with multiple functions and therefore funding sources, they are less conducive to procedural charges associated with certain medical devices such as lasers. So called per use charges have become commonplace in ophthalmology and other medical fields, allowing surgeons and facilities to reduce large capital expenses via a per procedure charge. Examples of such fees include per use fees for excimer laser corneal refractive surgery and femtosecond laser corneal surgery.

More recently, lasers that can perform multiple surgical procedures during a single session have been developed, offering the potential to deliver more convenient, safer and more efficacious outcomes. For example, an integrated surgical process can be provided to include the following surgical steps:

1. aligning the eye along a selected axis of the eye;

2. marking at least one part of the eye or an image of the eye relative to the selected axis of the eye as a reference;

3. controlling a beam of laser pulses to at least one target in the eye based on the marking, such that the effect created by the laser pulses is also aligned relative to the selected axis of the eye;

4. proceeding after such alignment with one or more of the following procedures:
(a) remotely fragmenting and/or otherwise preparing the lens for removal;
(b) creating a partial or full thickness capsular incision for accessing the lens material to be removed, the entry port for an Intraocular lens (IOL) insertion and possible optimization of IOL positioning;
(c) creating corneal incision with partial or full thickness for accessing the interior of the eye to create an entry port for IOL insertion and possible optimization of self sealing and/or IOL positioning relative to corneal interventions; and
(d) entering physically into the eye and the capsule for lens removal and IOL insertion. This can include placement of removable trochars that traverse the corneal and or lens capsule incisions to maintain a water tight seal and thus maintain a more physiologic state in the anterior chamber and capsule of the eye, minimizing or eliminating the need for viscoelastic devices and reducing risk of improper or unpredictable positioning of the IOL by the elimination of folding or collapse of the capsular bag; and

5. performing corneal surgical procedures by directing a laser beam to corneal areas to sculpt or shape the cornea, possibly removing portions of the cornea, for improving or correcting a refractive error of the corneal area. These procedures can result in partial thickness and/or partially cut corneal incisions for the correction of pre-operative or anticipated post-operative refractive error such as radial keratotomy, astigmatic keratotomy, or limbal relaxing incision that can be used at the same time as the rest of the surgical procedure or left undisturbed for use on an as needed basis after surgery. These surgical steps can be accompanied by pre-procedure and post-procedure diagnostic imaging.

Modern laser surgical devices can perform more than one procedures and sub-procedures in an integrated manner. Some of these procedures can be aimed at treating the cataract medical condition, while others at improving a refractive function of the eye and thus may be termed elective or not covered by insurance or third party payers. In this and other related examples, the need to clearly differentiate charges for these different procedures by payer is apparent.

In other words, with the emerging technologies the so called therapeutic and elective procedures can be performed using the same instrument at the same setting.

Such arrangements can be efficient for both the patient and the surgical facility by reducing the number of visits a patient needs to make and the amount of time and equipment needed for surgery, as well as by delivering the best surgical and functional outcome. The current practice of billing a single procedure fee for such a procedure fails to differentiate the different surgical components that may fall under different categories of payment from patients, private or government insurers.

Next a billing method and a corresponding system is described that allow a proper differentiation of the components of a treatment and a corresponding billing procedure to parties covering those components.

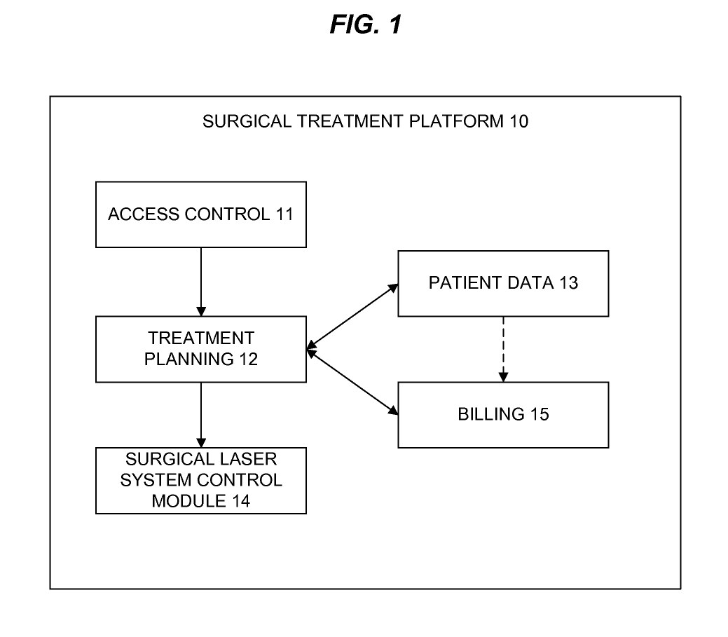

FIG. 1 illustrates that in one implementation, a surgical treatment platform 10 can include the following modules: access control module 11; treatment planning module 12; patient data management module 13; surgical laser system control 14; and billing control module 15. In various implementations one or more of these modules 11-15 can be integrated into a single module with multiple functions. The modules 11-15 can be accessed through user interfaces which may include a local keyboard, monitor or touch screen, local printer or any other types of remote devices. Remote devices or computers on a local area network or accessed through the internet can be particularly useful for verifying or granting access to the platform, entering patient's data and a treatment plan, outputting billing information, and performing remote diagnostics and service of the system.

The access module 11 can allow operators of the system to access the surgical treatment platform 10.

The treatment planning module 12 can present the operators with a menu 30, where they can input a treatment plan, which includes different procedures or combinations of procedures, as well as other selections.

The patient data management module 13 may assist the treatment planning module 12 by providing patient data and information regarding the patient's health care coverage, possibly including regional variations of the limitations of the coverage.

The treatment planning module 12 may exercise partial control over the surgical laser system control 14, to facilitate the performing of the laser ophthalmic surgery.

The billing module 15 can also interact with the treatment planning module 12, as described next.

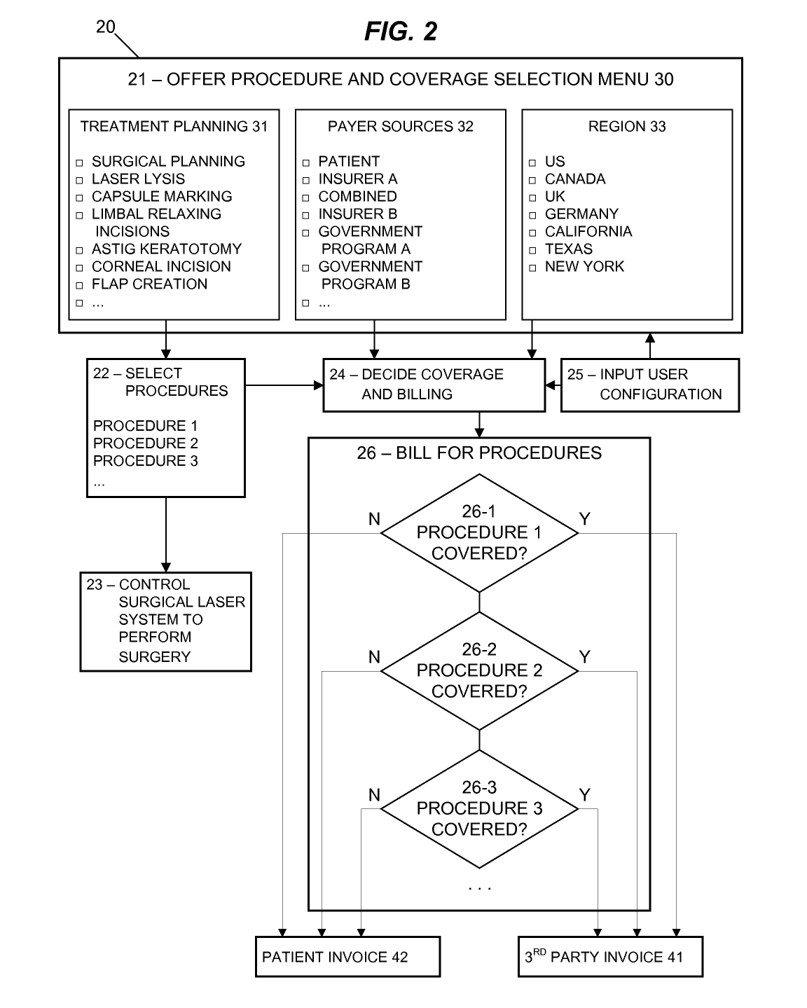

FIG. 2 illustrates a computer-automated billing process 20 in relation to the billing module 15. The billing process 20 can be implemented to automatically identify different costs associated with different procedures within the surgery and to perform different billing processes for different payers.

In step 21 the menu 30 can be presented to an operator or user of the system via a user interface. This user interface may support one or more of the modules 11-15.

In step 22 various surgical procedures 1, 2, 3 can be selected on the treatment planning interface/menu 31, related to the treatment planning module 12, constituting a treatment plan. Examples include checking the boxes on the treatment planning interface 31 for various procedures.

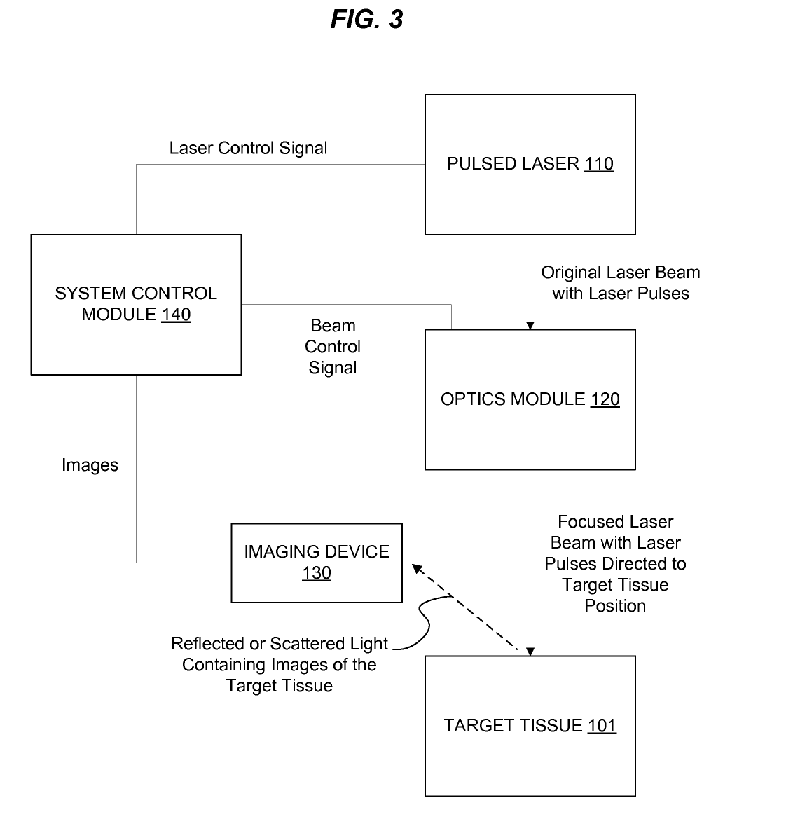

In step 23 the operator can access the surgical laser control module 14 to execute the selected surgical procedures of the treatment plan. One implementation of a surgical laser system 100 and its control module 14 are described below and illustrated in FIG. 3.

In step 24 the treatment planning module 12 can interact with the billing module 15. Performing step 24 can include:

(a) acquiring the treatment plan, including the planned/selected surgical procedures via the treatment planning interface 31;

(b) acquiring information regarding the patient's coverage, the policies and paying schedule of insurance policies via a “payer resources” interface 32; and

(c) acquiring information regarding factors which impact the payer resources through a “payer factor” interface 33, such as the region where the surgery is performed, as an insurer's coverage may vary from region to region.

In some implementations various characteristics of the user can be inputted by other means in a “user configuration” step 25.

Using the information about the patient's coverage and regional information such as the health care system in a particular country or state, an algorithm in the billing module 15 can determine how particular procedures within the treatment plan shall be billed.

Step 26 illustrates an embodiment of this (decision) algorithm. In step 26-1, the billing module 15 can consider procedure 1, which was selected to be part of the treatment plan through the treatment planning module 31. Based on the input from the payer sources interface 32, the payer factor interface 33, and possibly from a corresponding payer sources module, the billing module 15 can evaluate whether procedure 1 was covered by the patient's insurance. If yes, it was covered, then the billing module 15 may sort and direct the cost of procedure 1 to the invoice 41 addressed to the insurer of the patient. If no, procedure 1 was not covered, then the cost may be directed to the invoice 42 prepared for the patient.

These steps can be repeated for procedure 2 and 3. This step 26 results in separate invoices addressed to the patient and to his/her insurers.

Steps 21-26 can be performed interactively and iteratively.

In other embodiments multiple invoices can be produced, if the patient has a primary insurance provider and a secondary insurance provider. The corresponding evaluation steps can also be more complex, as both insurance providers may cover a particular procedure, but only up to a certain ceiling, or a preset percentage of its cost. In such implementations, the billing module may charge the cost of a procedure to the primary insurance provider up to its ceiling, or to the corresponding percentage, then proceed and charge the secondary insurance provider for the remainder of the cost, and if these residual costs exceed the ceiling of the secondary insurance provider, then to charge the patient for the remainder of the balance.

The billing module 15 can generate invoices, receipts, and/or other information for the user's own billing system or records. Charges may also be separated according to payer, as well as provider, allowing separate charges for surgeon and facility services.

An additional useful feature of the system is to allow users to configure procedure and coverage selection menus 31-33 based on coverage and billing algorithms that are locally applicable. For example, default treatment plans with pre-determined procedures, default regional information can be set and modified as pricing, coverage and tax laws change. Output preferences, such as printing an invoice, or a receipt, or creating an electronic transmission of information are also configurable.

In some implementations the surgical treatment platform 10 can bill multiple payers for portions of the cost of a single surgical procedure. In these implementations the patient data management module 13 can provide information that e.g. the patient's insurance plan from her primary insurance provider covers only a percent of the cost of the selected surgical procedure. However, the patient may have a secondary insurance provider as well. The insurance through this secondary insurance provider may be billed for the remaining balance of the cost.

The options related to these partial coverages can be displayed via the coverage selection menu 30. This can be done in multiple ways, including:

1. displaying percentages taken from the insurance plans: Insurer A—60%, Insurer B—40%;

2. displaying selectable percentages, offering a dial or slideable bar for an operator of the treatment platform 10 to enter selected percentages, possibly also indicating the maximum selectable percentage for the selected payer; and

3. displaying options to be sorted out by the billing module 15, such as: “distribute costs in the order of priority: insurer A, Insurer B, Government agency A, etc.”

Other implementations may distribute portions of the cost among multiple payers in different but analogous manners.

The following sections describe additional information on the surgical aspects of the systems.

The first category of surgical processes can involve removal of the entire lens substance to create a lens capsule using various techniques, including use of ultrasound, heated fluids or lasers. The entirety or a portion of the lens capsule may be used to provide a space for placement of an artificial lens of various materials and designs.

The second category can include lens surgery procedures that do not remove lens material and provide an alteration in lens behavior or shape mediated by the biological response of adjacent untreated tissue. Cataract surgery is one of the most common ophthalmic procedures performed. The primary goal of cataract surgery is removal of the defective lens and replacement with an artificial lens or intraocular lens (IOL) that is optically superior to the natural lens. Generally, the superiority of the IOL over the damaged native lens is in terms of greater transmission of light, with reduced scattering and/or absorption.

Such procedures have been widely used and the ultrasound phacoemulsification in such procedures remains largely unchanged over the past 20 years. In phacoemulsification, a series of individual surgical maneuvers are undertaken, including (1) Corneal incision and paracentesis; (2) Injection of viscoelastic to maintain anterior chamber; (3) Incision of anterior capsule; (4) Creation of anterior capsulorhexis; (5) Hydrodissection of lens nucleus; (6) Fragmentation (mechanical and ultrasound) and aspiration of lens nucleus; (7) Aspiration of lens cortical material; (8) Injection of viscoelastic into capsular bag; (9) Insertion and positioning of intraocular lens; (10) Removal of viscoelastic; and (11) Examination of corneal wound integrity, possible suture placement. These steps are usually necessary due to the requirement for entering the eye physically with instruments to break up and remove the lens.

The surgical steps described above may require a high level of skill by the surgeon and specialized equipment and supplies, many of which require the assistance of a scrub nurse. Because each step is separate from others, the steps may be difficult to be optimally coordinated with one another during the procedure. As such, a surgery performed based on the above and other separate surgical procedures for cataract surgery can suffer various limitations. For example, these procedures may produce corneal incisions that are not sufficiently predictable in size, shape and location and thus result in lack of self-sealing of the wound, the requirement for sutures, prolapse of iris tissue into the wound, and difficulty in accessing lens material for removal and implantation of IOL. These procedures may also cause undesired elevated eye pressures due to residual viscoelastic agents that block drainage channels of the eye. In addition, these procedures may lead to non-optimally centered, shaped or sized capsule openings which can cause complication in removal of lens material and/or limit the precision in positioning and placing IOL in the eye.

These and other limitations and associated risks in cataract surgery using phacoemulsification have led to development of procedures for treating cataract without making an incision in the eye. For example, some methods reduce the opacity of the lens by directing ultrashort laser pulses to locations of low opacity in the eye. This method, however, could be limited in some aspects. When an eye condition is caused by problems other than lens opaqueness such as concomitant refractive error, it may need separate procedures and treatment.

Until recently cataract or lens removal surgery was used primarily to remove an aged natural lens and replace it with an artificial lens (intraocular lens, IOL) that had greater light transmission. Cataract surgery is one of the most commonly performed ophthalmic procedures worldwide and its goals have expanded to also include improvement in the refractive functioning of the eye. In fact, lens removal and replacement is now commonly performed when little to no cataract is present, and refractive or optical correction is the primary goal.

Current lens surgery goals also include reducing a person's dependence on glasses and other optical aids both for distant and near vision. Specific lens replacement procedures and devices include the placement of multifocal IOL's that provide two working distances for the eye (See Restore, developed by Alcon, Rezoom). There are now also IOL's that can move or change shape in the eye, as in accommodating IOL's (see Crystalens, developed by Eyeonics). IOL's with apertures that increase depth of field are also being developed (see ACI-7000™ developed Acufocus, described in http://medgadget.com/archives/2007/01/the_acufocus_ac.html). In addition, IOL's that can correct higher order aberrations, such as the Light Adjustable Lens (LAL®) by Calhoun Vision, as well as those that correct astigmatism have also been developed. Finally, specialized low vision intraocular lenses have also been introduced to provide magnification for eyes with diseased retinas. When compared with standard cataract surgery using monofocal IOL's, current lens surgery has become a more complicated procedure able to address multiple vision correction goals. In contrast to standard monofocal IOL's, the optics of these newer devices are more sensitive to errors in centration or tilt. While methods to properly center these devices have been described (such as described by Maskett in U.S. Patent Application Publication No. 20040106929) they utilize cumbersome templates that must be physically inserted into the eye and have not gained favor.

Further, complexity to appropriate alignment of refractive eye procedures has been generated, when multiple interventions in the cornea and/or lens are used in conjunction with each other. While such combined procedures offer the potential for enhanced outcomes, they also have the potential to introduce unwanted side effects due to unanticipated combined optical effects. For example, placement of a multifocal intraocular lens combined with performance of astigmatic keratotomy can provide a patient with good distance and near vision by concurrently addressing presbyopia, spherical and astigmatic refractive error. However, if the optical center of the multifocal lens is not well situated with respect to the corneal correction, or if either correction is not well situated with respect to one of the primary axes of the eye, then optical aberration may occur.

Similarly, if LASIK is performed for distance refractive correction and a corneal inlay is placed to enhance near vision, enhanced performance may be obtained. However, if the optical center of the LASIK procedure is not well situated with respect the corneal inlay, or either manipulation is not well situated with respect to one of the primary axes of the eye, then optical aberration may occur, along with visual symptoms.

While these are two examples, a number of other possible procedure combinations can be envisioned to interact constructively or destructively, including combination procedures that are entirely contained within the cornea or lens. Such combinations can also include corneal inlays (such as Intacs developed by Addition Technology, http://www.getintacs.com/us/ati/index.html ) or presbyopic inlays (such as developed by Revision Optics and the ACI-7000™ developed Acufocus), as well as artificial pupils placed in front of (or behind) a natural or artificial lens. While each individual procedure can be aligned according to methods used when performed separately, such multiple alignments are time consuming and may not result in optimized performance when combined.

Thus, in order to exert the desired effect, the changed optics of the post-surgical eye should be aligned with both with the pupil and the central portion of the retina.

The various relationships between the optical components of the eye have been defined by a set of axes, known clinically as the primary axes of the eye, as listed below (adapted from. Grand Y.L. Physiological Optics, Springer-Verlag, N.Y., 1980):
Optical axis: Line passing through the optical center of the cornea and lens.
Visual axis: Line passing from the point of fixation to the image on the center of the fovea.
Line of Sight: Line passing from the object point through the center of the entrance pupil.
Pupillary axis: Line passing perpendicularly through the center of the cornea and the center of the entrance pupil.

While it may seem ideal to align all the optical elements of the eye along the visual axis, there are practical limitations that generally make this harder to achieve. For example, the optical center of the cornea and lens, the major refractive elements of the eye, are generally not naturally aligned, with the center of the lens slightly nasal to that of the cornea. In addition, the center of the pupil is not generally centered under the cornea and lens, or over the fovea. Adding to this complexity are the practical limitations to clinically identifying certain critical landmarks. For example, most eye surgeries are performed with the patient in the supine position (looking up), which changes the eyes rotational state (cyclotorsion) from that seen in the upright position. Thus, any alignment procedure performed in the supine position can introduce refractive errors (in astigmatism and asymmetric higher order aberrations) that are not symmetric around the pupil.

A number of devices and methods have been devised to more accurately align surgical interventions of the eye. In a simple example, when refractive surgery is to be performed on the cornea, the patient can be asked to fixate on an appropriate target. The position of the image of center of the pupil can be marked with ink or indentation on the cornea to estimate the line of sight. If performed in the upright position, marks can also be made in the peripheral cornea or limbus to register the torisional position of the eye for reference when the patient is supine. Alternatively, the position of the image of center of the pupil can be marked with ink or indentation on the cornea overlying the center of the cornea as indicated by the corneal light reflex (Purkingee image), thus approximating the pupillary axis.

While the above methods have been used in a number of surgeries, including limbal relaxing incisions/astigmatic keratotomy and radial keratotomy, surface marking can introduce potential errors due to the optical effects of the cornea and the location of the lens/pupil diaphragm several millimeters away. For example, during procedures that take more than a few seconds, such as corneal laser refractive procedures like PRK and LASIK, the actual position of the pupil can rotate significantly relative to corneal marks and the perceived image of the pupil, potentially introducing significant tilt errors to any surgical intervention. To overcome this, so called pupil trackers, that monitor for such movement have been developed. The most accurate of these now utilize sophisticated image processing to monitor the position of specific iris features (see the iris registration description by the VISX corporation).

Appropriate alignment of intraocular surgeries presents another set of challenges. In such procedures, the actual target of the procedure, the lens of the eye for instance, cannot be marked physically without entering the eye, which itself can alter shape, position and/or fixation. Corneal marks can be utilized, however once again the accuracy of such marks is limited with respect to structures inside the eye. This is further complicated by the need to dilate the pupil during such intraocular procedures, making the latter even less useful as a registration landmark.

Laser-induced photodisruption is a nonlinear optical interaction between light and a tissue that causes the tissue to ionize. Laser-induced photodisruption can be used to selectively remove or disrupt tissue in various surgical procedures, such as laser surgery in ophthalmology. One important aspect of laser surgical procedures is precise control and aiming of a laser beam. Laser surgery systems can be designed to include laser control and aiming tools to precisely target laser pulses to a particular target inside the tissue.

One technique to facilitate and control precise, high speed positioning requirement for delivery of laser pulses into the tissue is attaching a applanation plate made of a transparent material such as a glass with a predefined contact surface to the tissue so that the contact surface of the applanation plate forms a well-defined optical interface with the tissue. This well-defined interface can facilitate transmission and focusing of laser light into the tissue to control or reduce optical aberrations or variations (such as due to specific eye optical properties or changes that occur with surface drying) that are most critical at the air-tissue interface, which in the eye is at the anterior surface of the cornea. A number of contact lenses have been designed for various applications and targets inside the eye and other tissues, including ones that are disposable or reusable. The contact glass or applanation plate on the surface of the target tissue is used as a reference plate relative to which laser pulses are focused through the adjustment of focusing elements within the laser delivery system relative. Inherent in such an approach are the additional benefits afforded by the contact glass or applanation plate described previously, including control of the optical qualities of the tissue surface. Accordingly, laser pulses can be accurately placed at a high speed at a desired location (interaction point) in the target tissue relative to the applanation reference plate with little optical distortion of the laser pulses.

As an example, U.S. Pat. No. 5,549,632 by Lai describes a laser surgical system that uses an applanation plate on an eye. The applanation plate is described by Lai to serve at least one of the following three functions: 1) the applanation plate can provide a positional reference for the surgical laser, 2) the applanation plate can control the shape of the of the surface of the laser target (the cornea) and 3) the applanation plate can reduce the distortion of the laser surgical beam at the surface interface. In order for the system described by Lai to function appropriately for positional reference, three conditions must be satisfied: 1) the desired location of laser pulse focus in the target must be known with sufficient accuracy prior to firing the laser pulses; 2) the relative positions of the reference plate and the individual internal tissue target must remain constant during laser firing; and 3) the focusing of the laser pulse to the desired location must be predictable and repeatable between eyes or in different regions within the same eye. While these conditions can be met for some of the superficial corneal applications envisioned by Lai, it can be difficult to use the system described by Lai to precisely localize laser pulses intraocularly, when such conditions are not met.

FIG. 3 illustrates an example of a laser surgical system that can implement the fixation ring, the applanation lens and the centration of the applanation with respect to the laser delivery path and the eye. A pulsed laser 110 is provided to produce desired surgical laser pulses to perform surgery on an eye 101. The laser 110 may also be operated to produce preliminary laser pulses to pre-treat a portion of the eye 101 prior to delivery of the surgical laser pulses to facilitate the laser surgery by the surgical laser pulses. An optics module 120 is provided to focus and direct the laser beam to the eye 101. The optics module 120 can include one or more lenses and may further include one or more reflectors. A control actuator is included in the optics module 120 to adjust the beam focusing and the beam direction in response to a beam control signal. A system control module 140 is provided to control both a pulsed laser 110 via a laser control signal and the optics module 120 via the beam control signal. An imaging device 130 is provided to collect reflected or scattered light from the eye 101 to capture images of the eye 101. The captured imaging data is sent to the laser system control module 140 for controlling the laser operation. This control can include a dynamic alignment process during the surgical process to ensure that the laser beam is properly positioned at each target position in the eye 101. The imaging device 130 can be implemented in various forms, including an optical coherent tomography (OCT) device and an imaging sensor array.

Since patient satisfaction is a critical component to successful practice, there is a need to increase the likelihood that procedures combine to give desired optical effects and to avoid negative effects. Thus from the above discussion, one can see that there is a need for treatments involving combinations of different ophthalmic procedures and improved alignment methods for ocular refractive procedures, specifically one that can account for torsion and other ocular movements that can occur between marking and the surgical procedure or individual surgical steps, parallax and other optical effects, and that can be used to coordinate multiple separate interventions conveniently and efficiently to optimize total post-operative optical performance.

Based on the above, treatments involving combinations of different procedures using a single instrument and surgical setting present opportunities for improved outcomes and convenience. However, such treatments can introduce difficulty in handling procedure charge accounting when multiple potential payment sources are involved. Different procedural components may fall under different categories of payment from patient and third party sources. Current practice of billing for the whole treatment does not allow the differentiation between these categories and therefore, does not allow proportioning of the billing for the services rendered. The techniques described in this document can be used to provide proper differentiation of the components of a treatment and billing to parties covering those components.

While this specification described various embodiments and implementations, these should not be construed as limitations on the scope of an invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Also, enhancements, combinations, extensions and variations can be made, all within the scope of the attached claims.

What is claimed is:

1. A control system to bill for surgical procedures, the system comprising:
a treatment planning module to accept input selecting multiple surgical procedures;
a patient data management module to provide patient data; and
a billing module to charge different payers for the selected surgical procedures in relation to the patient data,
wherein the control system is operable to communicate with a surgical apparatus, configured to perform the selected multiple surgical procedures.

2. The system of claim 1, wherein the patient data comprises:
data regarding coverage of the selected procedures by an insurer of the patient.

3. The system of claim 1, wherein the different payers comprise at least one of:
two or more insurance companies; and
an insurance company and the patient.

4. The system of claim 1, wherein different procedures are charged to different payers.

5. The system of claim 1, wherein portions of a cost of different procedures are charged to different payers.

6. The system of claim 1, wherein the system comprises a user interface to provide menus for a user of the system.

7. The system of claim 6, the menus comprising:
a treatment planning menu to select surgical procedures;
a payer sources menu, to input identification of the different payers; and
a payer factor menu, to input factors impacting coverage by the different payers.

8. The system of claim 1, wherein the system is configured to perform an algorithm to charge the different payers in relation to the patient data.

9. The system of claim 8, wherein the algorithm comprises:
evaluating whether a selected procedure is covered by a payer at least partially;
charging at least a part of the cost of the selected procedure to the payer if the selected procedure is covered by the payer at least partially; and
charging another party if the selected procedure is not covered by the payer.

10. The system of claim 1, wherein one of the selected surgical procedures is a cosmetic or convenience procedure.

11. The system of claim 1, wherein the selected surgical procedures involve surgery on an eye.

12. The system of claim 11, wherein one of the selected procedures is a portion of a cataract surgery.

13. The system of claim 12, wherein another selected procedure is a corneal procedure.

14. A computer-implemented method of billing for surgical procedures, the method comprising the steps of:
accepting input for selecting multiple surgical procedures;
accepting input regarding patient data; and
charging different payers for the selected surgical procedures in relation to the patient data.

15. The method of claim 14, wherein the patient data comprises:
data regarding coverage of the selected procedures by an insurer of the patient.

16. The method of claim 14, wherein the different payers comprise at least one of:
two or more insurance companies; and
an insurance company and the patient.

17. The method of claim 14, wherein different procedures are charged to different payers.

18. The method of claim 14, wherein portions of the cost of different procedures are charged to different payers.

19. The method of claim 14, further comprising:
providing menus for a user of the system.

20. The method of claim 19, the menus comprising:
a treatment planning menu to select surgical procedures;
a payer sources menu, to input identification of the different payers; and
a payer factor menu, to input factors impacting coverage by the different payers.

21. The method of claim 14, wherein the charging step comprises:
performing an algorithm to charge the different payers in relation to the patient data.

22. The method of claim 21, wherein the performing the algorithm comprises:
evaluating whether a selected procedure is covered by a payer at least partially;
charging at least a part of the cost of the selected procedure to the payer if the selected procedure is covered by the payer at least partially; and
charging another party if the selected procedure is not covered by the payer.

23. The method of claim 14, wherein one of the selected surgical procedures is a cosmetic or convenience procedure.

24. The method of claim 14, wherein the selected surgical procedures involve surgery on an eye.

25. The method of claim 24, wherein one of the selected procedures is a portion of a cataract surgery.

26. The method of claim 24, wherein another selected procedure is a corneal procedure.

27. A control system to bill for a surgical procedure, the control system comprising:
a treatment planning module to accept input selecting a surgical procedure;
a patient data management module to provide patient data;
a billing module to charge different payers for portions of the cost of the selected surgical procedure in relation to the patient data; and
a surgical interface to communicate with a surgical apparatus, configured to perform the selected surgical procedure.

28. A computer-implemented method of billing for a surgical procedure, the method comprising the steps of:
accepting input selecting a surgical procedure;
accepting input regarding patient data; and
charging different payers for portions of the cost of the selected surgical procedure in relation to the patient data.
